(19) United States
(12) Patent Application Publication
(10) Pub. No.: US 2025/0283768 A1
(43) Pub. Date: Sep. 11, 2025

(54) THREE-DIMENSIONAL FORCE MEASUREMENT DEVICE AND LOAD CELL THEREFOR

(71) Applicant: Tom Van Esch, Bloomfield Hills, MI (US)

(72) Inventor: Tom Van Esch, Bloomfield Hills, MI (US)

(21) Appl. No.: 18/600,701

(22) Filed: Mar. 9, 2024

(51) Int. Cl. G01L 5/22; G01L 5/1627

(52) U.S. Cl. CPC G01L 5/223; G01L 5/1627

(57) ABSTRACT

Disclosed herein is a torque insensitive three dimensional force measurement device and load cell therefor. A pivotally movable load element eliminates torque by moving independently of a sensor. The load element aligns with the direction of an input force. The pivotally movable load element decomposes an input force vector into force components that are measured by at least three radially symmetric beams spaced about a central axis. Each of the beams has a fixed end and a free end. The beams are operatively constrained at their fixed end and free to deflect at their free end. Each of the beams is disposed to deflect independently from a component force transmitted by the load element. Each beam has at least one strain gauge operatively bonded thereto. A force measurement device further comprises a base, circuit board, nonvolatile memory, random access memory, a processor, and a display screen.

### FIELD OF TECHNOLOGY

The present invention relates to load cells, and more particularly, to three-dimensional load cells capable of uncoupling torque effects.

### BACKGROUND

When a force is applied to fixed object, the object will undergo stress and strain. Stress is the amount of force applied to a member divided by the member's cross-sectional area. Strain is the deformation or displacement of material that results from the applied force. A strain gauge is an electrically resistant wire gauge that is bonded to a member to measure surface strains. A strain gauge will measure the change in deformation by providing a signal in the form of resistance, and by knowing its sensitivity to strain, referred to as the gauge factor, Hooke's law may be used to determine the stress. The change in resistance from the strain gauge is too small to be used directly, so amplification is used with a metering discriminator to measure the magnitude of the strain.

The most common way to measure a change in resistance is by a Wheatstone bridge, although other circuits may be employed such as the Chevron bridge, four-wire ohm circuit, or constant current circuit. To filter environmental effects, a “dummy” strain gauge may be bonded on an unstressed portion of a member. For dynamic strains, a ballast circuit may be used, which incorporates a capacitor used to filter static strains. Strain gauges are commonly found in load cells.

A load cell is a type of force sensor that, when connected to an appropriate circuit, returns a signal proportional to the mechanical force applied to the load cell. A load cell can be hydraulic, pneumatic or, most commonly, strain gauge based. Strain gauge load cells operate on deformation of the member and the strain gauge bonded to the member. The force applied to the load cell is measured by a change in resistance by the strain gauges. There are many types of commercially available load cells.

S-beam load cells are commonly used for weight or force measurement applications. When a force is applied, the middle of the beam acts as a spring and compresses or elongates by elastic deformation proportional to the force applied. However, S-beam load cells are very sensitive to torque and any off-center loads.

Shear beam load cells are commonly used for compression measurements in industrial weighing applications. Shear beam load cells measure the shear strain on the beam. A shear beam load cell has pockets machined on each side of the beam to create an I-beam section to provide a surface to mount the strain gauges. Shear beam load cells are used in applications such as weighing tanks in factories or on vehicles, and on platforms, conveyors, and container scales. Although shear beam load cells offer a good solution for heavy, linear forces, they are unaffected by lateral forces, as a result, those forces are not measured. Shear beam load cells are obviously unsuitable for multidimensional forces.

Button load cells are popular for low capacity measuring applications. A button load cell typically uses a diaphragm construction with strain gauges bonded to the diaphragm. For higher precision applications, bending beams may be used. A bending beam load cell is one type that has the strain gauge laminated on the top of the beam surface. A button load cell is suitable for a force in a single direction and is therefore unsuitable for multidimensional forces. Side load and torque are a concern with button load cells as these forces are known to damage button load cells. A deficiency with all load cells is they are designed for a linear force in a particular direction—a vector force—and are not able to decouple torque moments.

Three dimensional, or three axis, load cells measure forces in three perpendicular (orthogonal) directions. Each axis of force measurements is coupled to the others; therefore, torque is present in these three dimensional load cells. State of the art 3D load cells and are limited by torque capacity. According to performance information from commercially available 3D load cells, a typical ratio of linear load to torque capacity is 100:1. Although these load cells are capable of measuring 3D forces, their intolerance to torque makes these devices unacceptable. Even if torque capacity was improved, the current commercially available 3D load cells are still not capable of decoupling torque.

Multidimensional force sensors, such as those for haptic interaction, are capable of measuring 6-axis force and/or torque through the use of an elastic sensing element. Although 6-axis force sensors provide more information than the above referenced load cells, they are still not able to decouple torque. Accordingly, there exists a need in the art to provide a sensitive 3D load cell with torque insensitivity.

As may be seen above, load cell measurement has been a relative concept. A force on the handle of an automotive door is a vector—that is, it has a magnitude and direction. A load cell of the prior art placed between that force vector and the handle of the automotive door can only measure a force or forces in a particular orientation. If the orientation of the load cell is misaligned with the direction of a force, i.e. an off-center force vector, and that force must be measured, decoupling torque is a necessity. One reason is a component of the misaligned force is not being measured.

Another reason is torque must be decoupled is the off-center force vector, which could be described as a “spurious force,” which results in a positive or negative parasitic load affecting the reading of a load cell. The bending moment from the spurious force will create a reaction force which will either bend more (add to the load) or bend less (subtract from the load). These spurious forces may result from issues such as misalignment of the load cell or the input force being applied at an off-center angle. When measuring the closing force of an automotive door, for example, the real work and measured work will not be the same because the parasitic load inside of the load cell will not be accounted for in measuring closing force. Decoupling torque caused by spurious forces solves this problem.

Accurate measurement of the three amplitudes of a three-dimensional force vector independent of any torque is highly desirable. This is an essential characteristic for several force measurement applications where highly accurate measurement of force interaction in an environment is required. Force vectors often change in an environment. One example of a variable force interaction in an environment is that of a human-based input. Human interaction provides innumerable variation with regard to force interaction. Human height, weight, body geometry and strength all provide different force interaction. These force interactions may be used to trigger signals and decisions in a process.

One such application would be in measuring the closing force of an automotive door. For example, in the case of automated doors when a human applies a force input, the controlling system will determine, based on, for example, amplitude, to start a motorized movement. Other door interactions can be subject to regulations that specify that a door should open under a certain applied force. The capability of obtaining more accurate measurements will allow these systems to receive better data and as a result, improve the response or quality of the product.

Steps taken to provide a three-dimensional load cell uncoupled from torque eludes the art. An exemplary embodiment may overcome these problems and provide an accurate three-dimensional load cell and measurement system while uncoupling torque.

### SUMMARY

A load cell comprises a pivotally movable load element having at least one spherical surface and a sensor to receive the load element. The surface of the load element may be generally spherical, substantially spherical, or comprise one or more spherical segments. The load element has an axis. The load element moves independently of the sensor.

The sensor comprises at least three radially symmetric beams spaced about a central axis. Each of the beams has a fixed end and a free end. Each of the beams is operatively constrained at its fixed end and is free to deflect at its free end. Each of the beams is disposed to deflect independently from a component force applied by the load element. Each one of the beams has at least one strain gauge operatively bonded to that beam.

In an alternative embodiment of the load cell each of the beams are constrained at a non-zero attitude. In still another alternative embodiment each of the beams are constrained at an attitude of 45 degrees. In still another alternative embodiment, the each of the beams has a contact shoe operatively attached to the beam adjacent to the free end. In still another alternative embodiment, the beams are spaced at about 120° increments. In still another alternative embodiment, the load element has an upper hemisphere and a lower hemisphere and the free end of each of the three radially symmetric beams are disposed to deflect independently from a component force applied from said lower hemisphere of said load element. In still another alternative embodiment, the sensor contacts the surface of the load element at a tangent to the surface of the load element. In still another alternative embodiment, each of the beams have a generally rectangular cross-section.

In yet another alternative embodiment, the load cell further comprises an inverted sensor that is axially spaced from, and inverted about the horizon with respect to, the sensor. The inverted sensor comprises at least three inverted beams axially spaced from, and horizontally inverted with respect to, the three beams of the sensor. The three inverted beams are radially symmetric and spaced about a central axis. Each of the inverted beams has a fixed end and a free end, where each of the inverted beams is operatively constrained at the fixed end and is free to deflect at its free end. Each of the inverted beams is disposed to deflect independently from a component force applied by the upper hemisphere of the load element. Each of the inverted beams has at least one strain gauge operatively bonded to the inverted beam.

In an alternative embodiment of the load cell, each of the inverted beams are constrained at a non-zero attitude. In still another alternative embodiment, a contact shoe is operatively attached adjacent to the free end of each one of the inverted beams. In still another alternative embodiment, the inverted beams are spaced at about 120° increments. In still another alternative embodiment, the load element has an upper hemisphere and a lower hemisphere and the free end of each of the three radially symmetric inverted beams are disposed to deflect independently from a component force applied from said upper hemisphere of said load element. In still another alternative embodiment, the inverted sensor contacts the surface of the load element at a tangent to the surface of the load element. In still another alternative embodiment, each of the inverted beams have a generally rectangular cross-section.

A force measurement device comprises a load cell having a pivotally movable load element which has at least one spherical surface. A sensor is disposed to contact the load element at a tangent to the surface of the load element. The sensor comprises at least three radially symmetric beams spaced about a central axis. Each of the beams has a fixed end and a free end. Each of the beams is operatively constrained at its fixed end and is free to deflect at its free end. Each of the beams is disposed to deflect independently from a component force applied by the load element. Each one of the beams has at least one strain gauge operatively bonded to that beam to provide resistance measurements. A bridge circuit is connected to each of the strain gauges and a voltage source. The bridge circuit has a differential voltage output to provide a voltage signal. An analog to digital converter receives the voltage signal and converts the voltage signal to signal data. A processor receives the signal data, executes instructions for processing the signal data and processes the signal data.

In an alternative embodiment of the force measurement device, non-volatile memory stores signal data and a program containing instructions for processing signal data. In yet another alternative embodiment of the force measurement device a display screen provides information to a user. In still another alternative embodiment, the force measurement device further comprises an inverted sensor, the inverted sensor is axially spaced from, and inverted about the horizon with respect to, the sensor. The inverted sensor contact the load element at a tangent to the surface of the load element.

A force measurement device comprises a housing and a load cell. The load cell has a pivotally movable load element with at least one spherical surface. A base supports at least three pedestals. A sensor comprises at least three radially symmetric beams spaced about a central axis. Each one of the beams have a fixed end and a free end. Each of the beams is operatively constrained at its fixed end by each of the three pedestals. Each of the beams are free to deflect at its free end. Each of the beams is disposed to deflect independently from a component force applied by the load element. At least one strain gauge is operatively bonded to each of the beams. Each of the strain gauges provide resistance measurements.

A bridge circuit is connected to each strain gauge and a voltage source. The bridge circuit has a differential voltage output that provides a voltage signal. A circuit board has an analog to digital converter that receives the voltage signal and converts the voltage signal to signal data. Non-volatile memory is adapted for storing a program having instructions and signal data. A processor is adapted for receiving signal data from the non-volatile memory, executing instructions for processing signal data and processing signal data. A display screen in communication with said circuit board.

### BRIEF DESCRIPTION OF THE DRAWINGS

While the claims are not limited to a specific illustration, an appreciation of the various aspects is best gained through a discussion of various examples thereof. Referring now to the drawings, exemplary illustrations are shown in detail. Although the drawings represent the illustrations, the drawings are not necessarily to scale and certain features may be exaggerated to better illustrate and explain an innovative aspect of an example. Further, the exemplary illustrations described herein are not intended to be exhaustive or otherwise limiting or restricted to the precise form and configuration shown in the drawings and disclosed in the following detailed description. Exemplary illustrations are described in detail by referring to the drawings as follows:

FIG. 1a is an environmental view of a state of the art energy measurement device known as EZEnergy, manufactured by EZ Metrology;

FIG. 1b is an environmental view of a state of the art button load cell;

FIG. 2a is prior art bending beam load cell;

FIG. 2b is an environmental view of one embodiment of a three dimensional load cell of the present disclosure having a pivotally movable load element and three beams where the load cell is mounted to an automobile door by a suction cup;

FIG. 3a is a front view of one embodiment of a load cell of the present disclosure having a pivotally movable load element;

FIG. 3b is a plan view of the load cell of FIG. 3a disclosing an inverted sensor;

FIG. 3c is a bottom view thereof disclosing a sensor;

FIG. 3d is a perspective view thereof;

FIG. 3e is a side view of the load cell of FIG. 3a with the upper chassis, inverted beams and spacers removed showing the pivotally movable load element in two positions, perpendicular and pivoted by angle ψ, changing the axis of the load element from Z to Z′;

FIG. 3f is a bottom view thereof with the load element in a balanced state after being pivoted by a force vector;

FIG. 3g is a perspective view of FIG. 3f having the pivotally movable load element removed to reveal the relationship of the beams as defined by angle β;

FIG. 4a is a plan view of a lower chassis and beams of one embodiment of a load cell of the present disclosure;

FIG. 4b is a perspective view of pivotally movable load element of a load cell;

FIG. 4c is a perspective view of a sensor comprising beams with strain gauges bonded thereon;

FIG. 4d is a perspective view of a load cell having a pivotally movable load element and inverted sensor comprising inverted beams with strain gauges bonded thereon;

FIG. 5 is an illustration of a circuit board;

FIG. 6a is a plan view of a chassis and beams;

FIG. 6b is a section cut along A-A of FIG. 6a;

FIG. 7a is a perspective view of one embodiment of a force measurement device according to the principles of the present disclosure;

FIG. 7b is a perspective view of the force measurement device of FIG. 7a with half shell top, latch and screen removed to reveal a three dimensional load cell;

FIG. 7c1 a bottom perspective view of a top plate revealing the lands;

FIG. 7c2, is a top perspective view of a top plate;

FIG. 7c3 is a perspective view of a beam;

FIG. 7c4 is a top perspective view of a pedestal;

FIG. 7c5 is a bottom perspective view of a contact shoe;

FIG. 7c6 is a perspective view of a contact shoe;

FIG. 7c7 is a top perspective view of an under plate revealing the lands;

FIG. 7c8, is a bottom perspective view of an under plate;

FIG. 7d is a perspective view of the force measurement device of FIG. 7b with the circuit board removed to reveal the three dimensional load cell; and

FIG. 7e is a perspective view of an alternative force measurement device of FIG. 7c with the with half shell bottom, a pedestal, beam and two contact shoes removed to more clearly view components of the three dimensional load cell.

For the purposes of promoting an understanding of the principles of the embodiment, reference will now be made to the embodiments illustrated the drawings and specific language will be used to describe the same. It will nevertheless be understood that no limitation of the scope of the embodiments is thereby intended. Any alterations and further modifications in the described embodiments and any further applications of the principles of the embodiments described herein are contemplated as would normally occur to one skilled in the art to which the embodiment relates.

### DESCRIPTION OF THE PREFERRED EMBODIMENT

Exemplary illustrations of a device for measuring force and a load cell therefor comprising a pivotally movable load element and at least three cantilever beams, referred to herein as “beams” or “beam,” spaced about a central axis are shown in the attached drawings. Although a load element having at least one spherical surface is suitable, it is preferred for the load element to have a substantially spherical surface. It should be understood that the load element surface may comprise one or more spherical segments.

Each beam, being a cantilever beam, has a fixed end and a free end. Each beam has a length defined by a local coordinate x from its fixed end, and, depending on the cross section, for example a rectangular cross-section, the beam would have a width and a thickness. It should be understood that the teachings herein are not limited to a rectangular section, rather any other suitable section may be substituted for a rectangular section within the scope of the present disclosure. A strain gauge is bonded to each of the beams to measure the bending force. Downward bending, or bending resulting in negative change in slope is commonly referred to as negative deflection. As used herein, downward bending is referred to as “compression.” This should not be confused with the convention of identifying the underside of a bending beam as being in compression and the top side being in tension.

The surface of the beams are preferably perpendicular to one another, permitting a square root of the sum of all squares method to be used with each measured amplitude to determine the magnitude of the force vector. The direction vector would be determined by calculating the cosine of each amplitude divided by the magnitude. It should be noted that three or more beams may be employed within the teachings of the present disclosure. As used herein “amplitude” refers to the component force measured at each beam. Then the square root of the sum of the squares method may be employed with each component force measured to determine the magnitude of the force vector. The cosine of each component may be calculated by dividing each component by the magnitude of the force vector. The vectors may then be converted to a coordinate system of choice.

Two geometrical figures are said to be congruent if there is an isometry that maps one to the other. In geometry, an isometry is a transformation of the plane that preserves the distance between points on the object and a reference point. Examples of isometry's are translations, rotations, and reflections. An isometry is a rigid transformation, which means the size or shape of the object does not change. A rotational isometry fixes one point, the rotocenter, and the object is rotated by the same amount around that rotocenter while preserving all distances between the image and rotocenter.

Those skilled in the art will immediately understand that a strain gauge is an electrical measurement device applied to the measurement of mechanical quantities. The strain gauge sensor possesses properties where its resistance varies with applied force. Likewise, those skilled in the art will immediately recognize that a load cell, which is typically based on strain gauges, is a type of force sensor that, when connected to appropriate electronics, will return a signal proportional to the mechanical force applied to the system.

As used herein “torque” shall refer to static torque, that is a force applied to a moment arm measured in foot-pounds or Newton meters, i.e., a torque moment. Existing load cells are designed to work in a single force direction, that is, normal to the surface, or a vertical load. A force acting in a non-normal direction (not perpendicular to the surface) will impart a torque to the load cell. The design of current load cells cannot decouple torque from linear force.

Torque is a problem in force sensors. Any existing multidimensional force measurement sensor is subject to combination of linear forces and torque. This creates a number of problems. The first problem is damage to the sensor resulting from excessive torque. The second problem is a lack of accuracy—the torque will impart a parasitic load on the beam. And finally, the direction of the force vector will not be accurate if torque is present.

To explain more thoroughly, consider a pancake load cell, which is designed to operate in shear. An off-center force will be measured by the load cell, however, the bending moment applied at each bridge is in a different direction. Although the force is in compression, some bridges will bend as if the load was in tension. In addition, the bridges in compression will act as though they are experiencing more compression because of the bending moment imparted on the bridge apart from the deflection imposed from the compression force.

The present disclosure provides a solution to the torque problem while providing an accurate measurement of the three amplitudes of a 3-dimensional force vector by eliminating torque from the system. A pivotally movable load element is substantially spherical, generally spherical or comprised of one or more spherical segments. The pivotally movable load element is in contact with a sensor at a tangent to the surface of the load element. The load element moves independent of the sensor and aligns itself with the direction of the force vector by pivoting about a central pivot point. A sensor includes at least three radially symmetric beams spaced about a central axis. Each beam has a strain gauge bonded thereto, and preferably the beams are perpendicular to one another and spaced at about 120 degrees apart. In the preferred embodiment, each beam is inclined at an attitude of 45 degrees to the horizon. In the preferred embodiment a sensing bridge is bonded to each beam. A sensing bridge is a strain gauge connected to a bridge circuit, such as a Wheatstone bridge. Preferably, each sensing bridge is also arranged in a radially symmetric pattern around the central axis, as each sensing bridge is operatively bonded to a beam. Each beam, through a contact shoe or other means, makes contact with the pivotally movable load element at a tangent to the surface of the load element. Each beam only senses compression and measures one vector component. The amplitude of each component force is measured and by applying the square root of the sum of the squares method, the resultant force may be calculated.

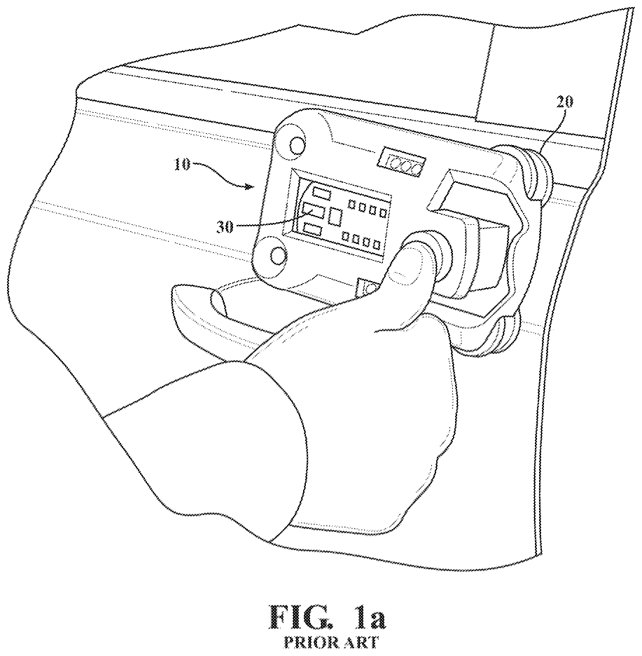

Referring now to FIG. 1a, an environmental view of a state of the art energy measurement device 10 known as EZEnergy, manufactured by EZ Metrology, is shown. The energy measurement device 10 comprises a base 20 and a screen 30. The EZEnergy device measures energy, force, and speed. It should be noted that in addition to force, displacement may also be measured, thereby calculating work. Work, like torque, is measured in foot-pounds or Newton meters. Energy is the capacity for doing work. Power is the result of how long it took to perform the work, typically measured in joules (Newton meters/second). Although the EZEnergy device is an outstanding piece of metrology equipment, it does not have the ability to eliminate torque from the system.

Referring now to FIG. 1b, an environmental view of a state of the art button load cell 33 is shown. Load cell 33 is known as a low profile load button with through holes, and is shown fixedly attached to a mounting bracket 32. These load cells are popular for measuring loads in compression, however, these load cells must not be used with off-center load or in a way that induced torque into the load cell.

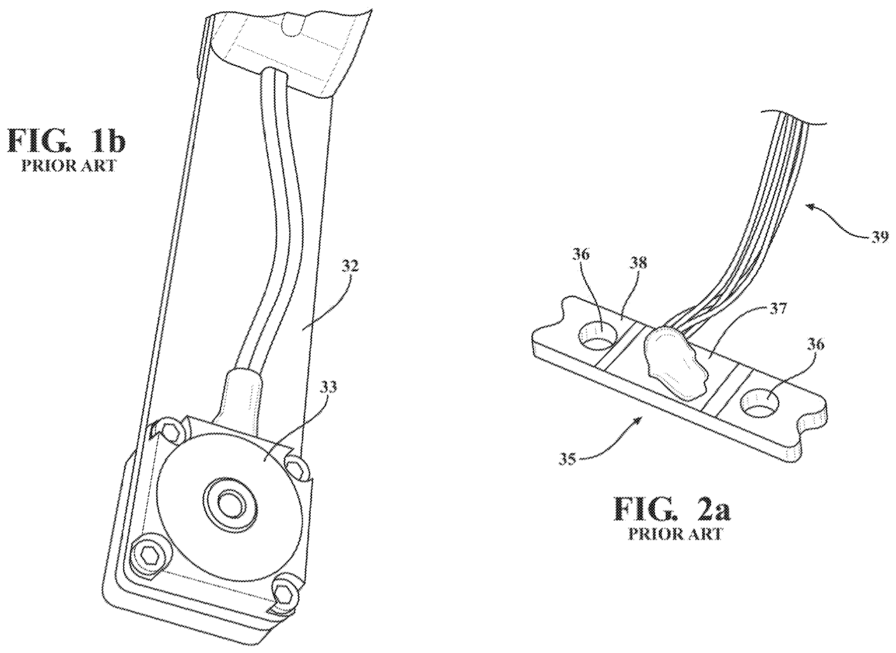

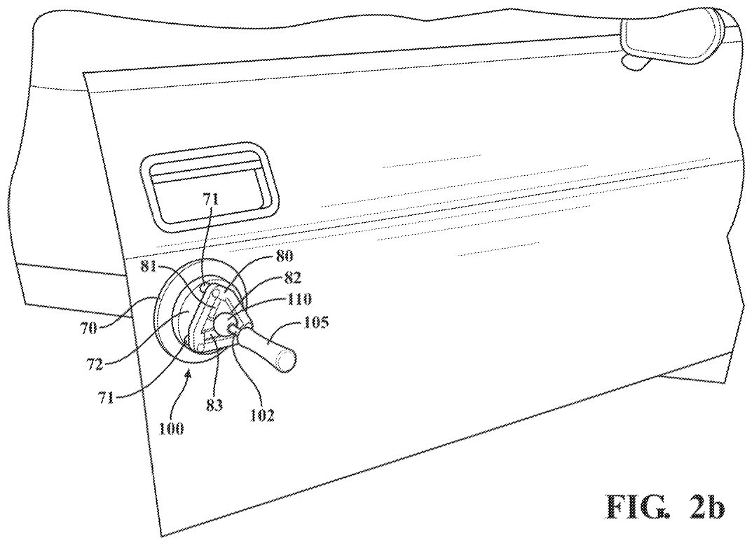

Referring now to FIG. 2a, a prior art bending beam load cell 35 is shown. The load cell 35 has a beam 38 with holes 36 at either end for mounting. A strain gauge (not shown) is bonded to the beam 38 by an appropriate adhesive. The strain gauge is connected to a bridge circuit (not shown), specifically a Wheatstone bridge and protected by potting material 37. Four wires 39 connect the bridge to a device for reading the strain measurement. According to convention the wires are organized as follows: red is positive excitation (V_{EX}+), white is negative excitation (V_{EX}−), black is signal positive (Vₒ+), and green is signal negative (Vₒ−). The measurement between Vₒ+ and Vₒ− is known as the differential voltage.

Plates (not shown) may be used to clamp a bending beam and may result in increased accuracy. A strain gauge is commonly a metallic foil arranged in a grid pattern parallel to the direction of the strain to maximize the amount of foil subject to strain. The grid is bonded to a thin backing called the carrier which is then bonded to the beam 38 to be measured. As force is applied to the beam 38, the beam 38 bends in response and strain increases, the parallel grid of the foil in the strain gauge is stretched causing its length to increase while its cross sectional area decreases, resulting in an increased resistance.

Referring now to FIG. 2b, an environmental view of one embodiment of a three dimensional load cell 100 of the present disclosure is shown mounted to an automobile door. The load cell 100 has three beams 81, 82 and 83 disposed to receive force transmitted from a pivotally movable load element 110. In the present embodiment, the pivotally movable load element 110 has a substantially spherical surface. The load cell 100 is shown attached to an automobile door by a by a mount 70, which in the present embodiment is a suction cup 70. The mount 70 is attached to a base 72 supporting a plurality of spacers 71. A frame 80 is axially spaced from the base 72 by the spacers 71. The beams 81, 82 and 83 are constrained at one end at the frame 80 and are free to bend from force applied by the pivotally movable load element 110 at the other. In the present embodiment, force may be applied from a handle 105 through a rod 102 to the pivotally movable load element 110. The embodiment of load cell 100 in FIG. 2b is a “push only” load cell which only measures forces applied toward the load cell 100.

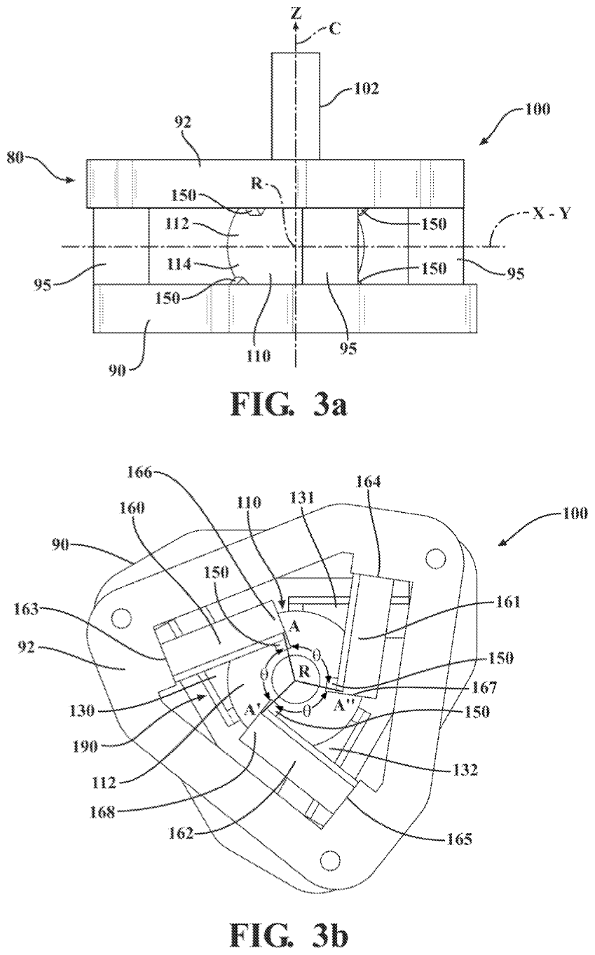

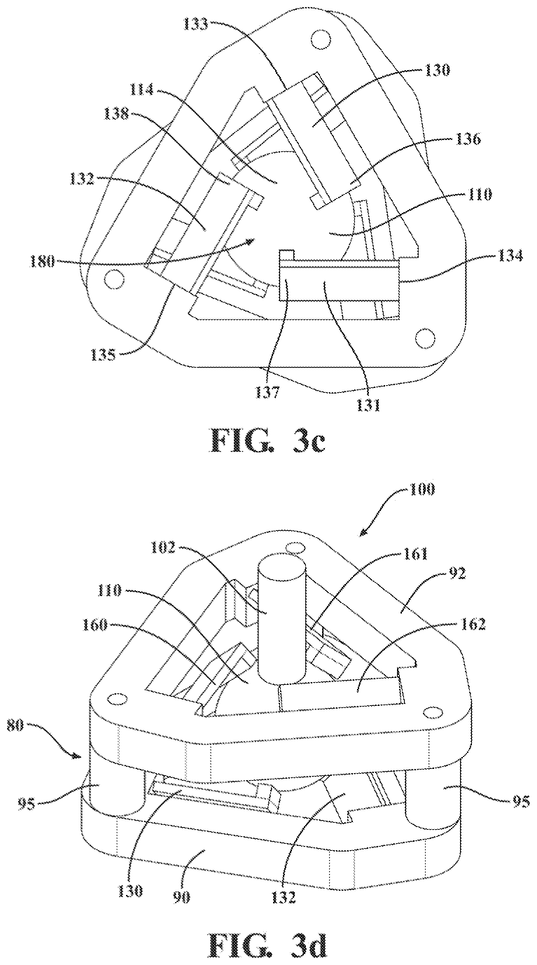

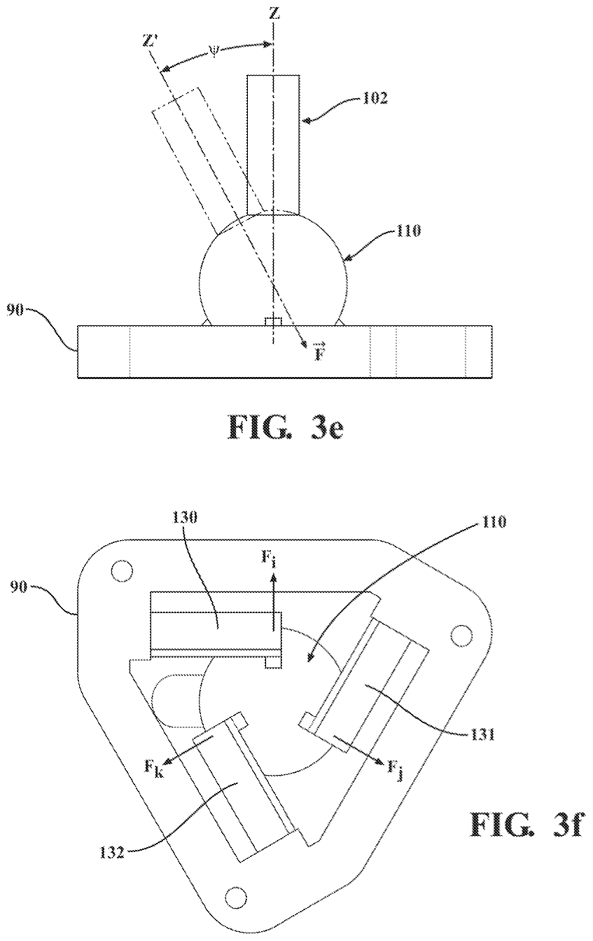

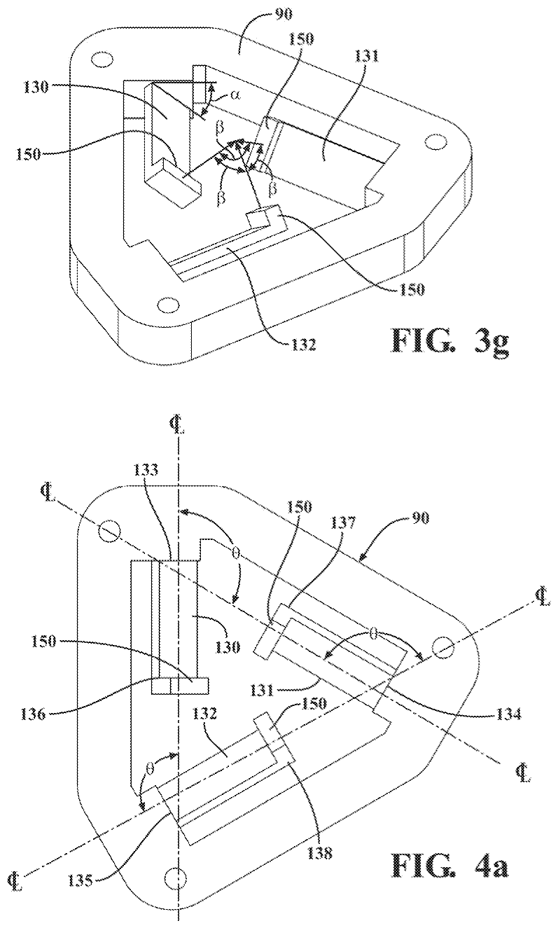

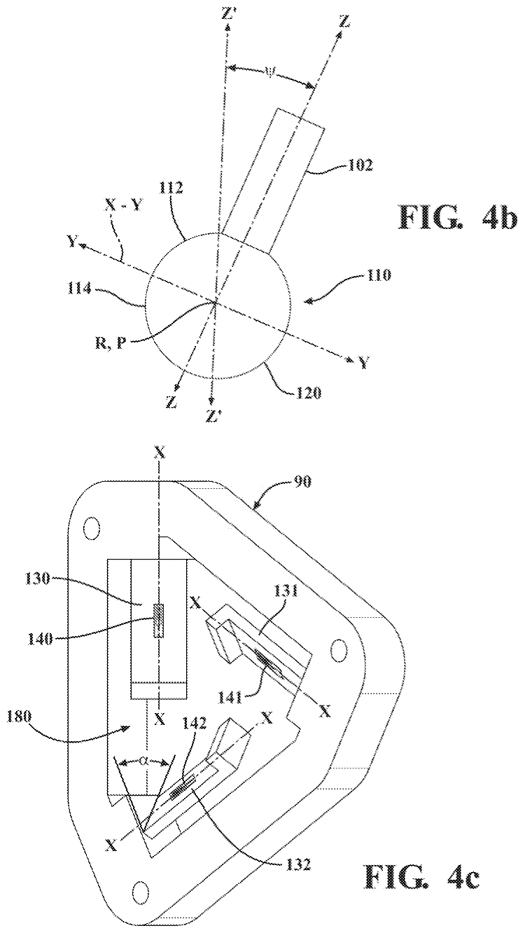

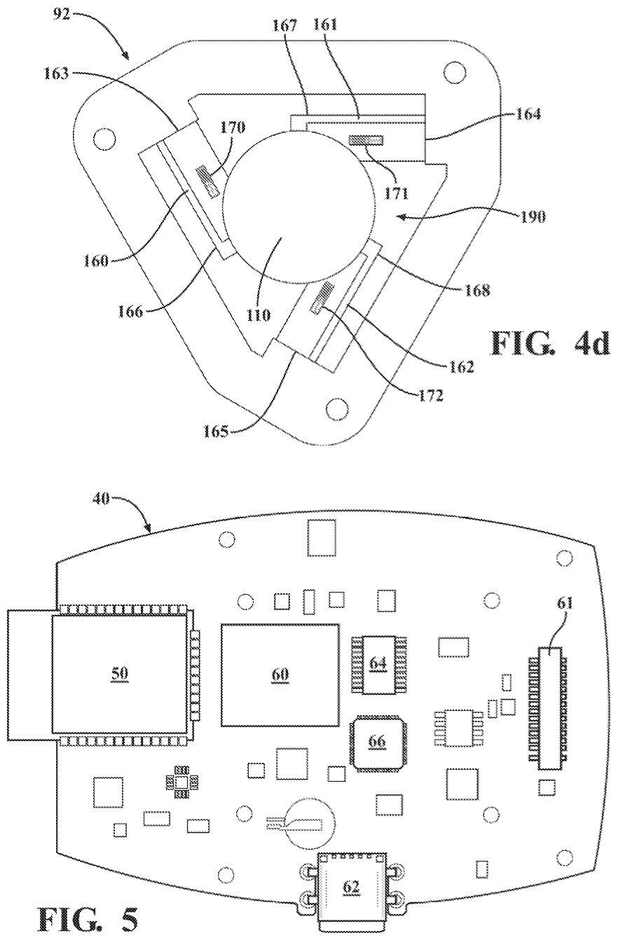

Referring now to FIG. 3a, a front view of one embodiment of a load cell 100 of the present disclosure is shown comprising a pivotally movable load element 110. A rod 102 extends from the load element 110. A frame 80 includes an upper chassis 92 axially spaced along a central axis C from a lower chassis 90 by a plurality of spacers 95, which in the present embodiment are pedestals 95. Because the load element 110 moves independently of the frame 80, a local Z-axis is provided on load element 110 to distinguish the z-axis of the load element 110 from the z-axis of the load cell 100. A plurality of contact shoes 150 are disposed to contact the load element 110 at a tangent to the surface 120, as shown in FIG. 4b, of the load element 110. An equatorial plane X-Y bisects the load element 110 into an upper hemisphere 112 and lower hemisphere 114.

The load cell 100 has a central axis C extending through the center of the load cell 100 and normal to the equatorial plane X-Y. In the immediate embodiment, a rotocenter R is located at the intersection of the equatorial plane X-Y and central axis C. The rotocenter R is the center of rotation for a rotational isometry, which in geometry is where an object is rotated to change the objects position or orientation, while preserving its size and shape.

Although disclosed in the present embodiment as pedestals, the spacers 95 may be substituted with a unitary spacer or any other object or objects of a suitable material and geometry to axially space the upper chassis 92 from the lower chassis 90. It is anticipated that the frame 80 would be machined from a block of metal, however it should be noted that the frame 80 may be a unitary member and or comprised of any suitable material known in the art.

Referring now to FIG. 3b, a plan view of the load cell 100 of FIG. 3a is shown revealing an inverted sensor 190. The sensor 190 is identified as “inverted” because it is axially spaced from, and horizontally inverted with respect to, sensor 180, as shown in FIG. 3c. The load element 110 moves independently from each sensor 180, 190. Each sensor 180, 190 or both make contact with the spherical surface 120, as shown in FIG. 4b, of the load element 110 at a tangent to the surface 120.

Inverted sensor 190 comprises three radially symmetric inverted beams 160, 161 and 162 spaced about the central axis C by an angle θ. That is, the beams 160, 161 and 162 are identical, and when the sensor 190 is rotated by an angle θ about its central axis, the sensor 190 looks the same. Angle θ is determined by θ=360/n where n=the order of rotation. The order of rotation happens to be the same as the number of beams comprising the sensor 190. Each of the inverted beams 160, 161 and 162 has a fixed end 163, 164 and 165 and a free end 166, 167 and 168 respectively. Each beam 160, 161 and 162 is operatively constrained at their respective fixed end 163, 164 and 165, in the present embodiment, by the upper chassis 92 of frame 80. The inverted beams 160, 161 and 162 are disposed to deflect from an input force applied by the upper hemisphere 112 of load element 110. Each of the inverted beams 160, 161 and 162 has a strain gauge (not shown) operatively bonded to each one of the inverted beams 160, 161 and 162.

A contact shoe 150 is operatively attached to each of the three inverted beams 160, 161 and 162 and to each of the three beams 130, 131 and 132. The contact shoes 150 provide a surface preventing the beams from becoming worn; the contact shoes 150 may be a consumable part that is replaceable. Those skilled in the art will immediately recognize that the beams 130, 131, 132, 160, 161 and 162 may be modified to directly contact the load element 110. However, the best mode includes incorporating contact shoes 150 as a replaceable component.

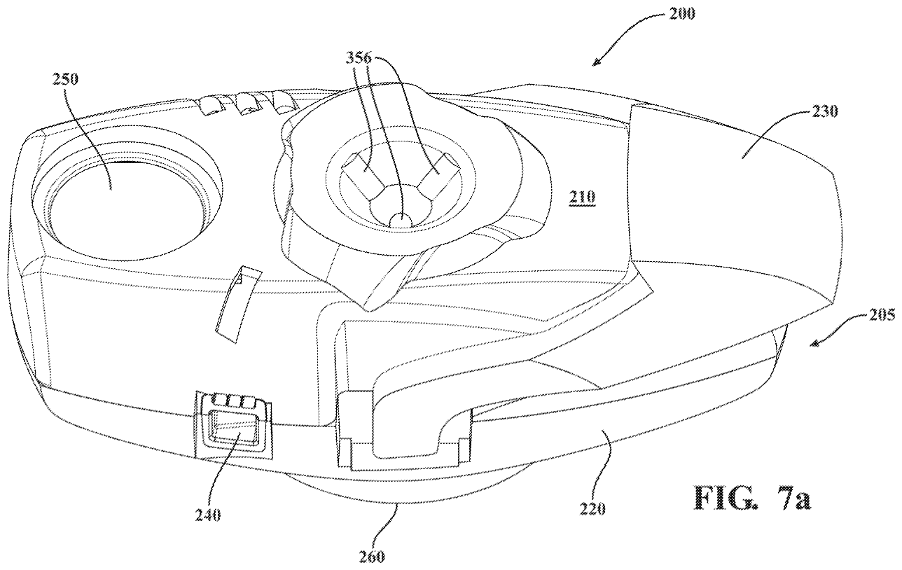

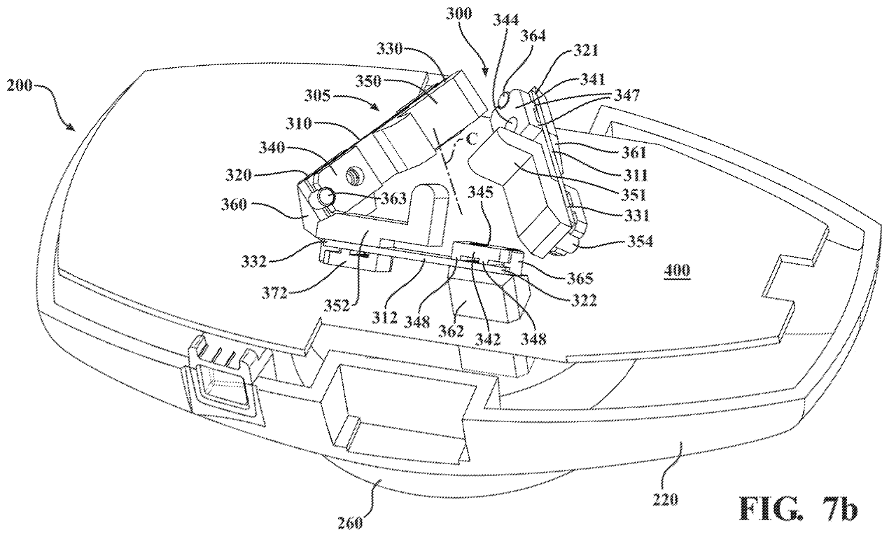

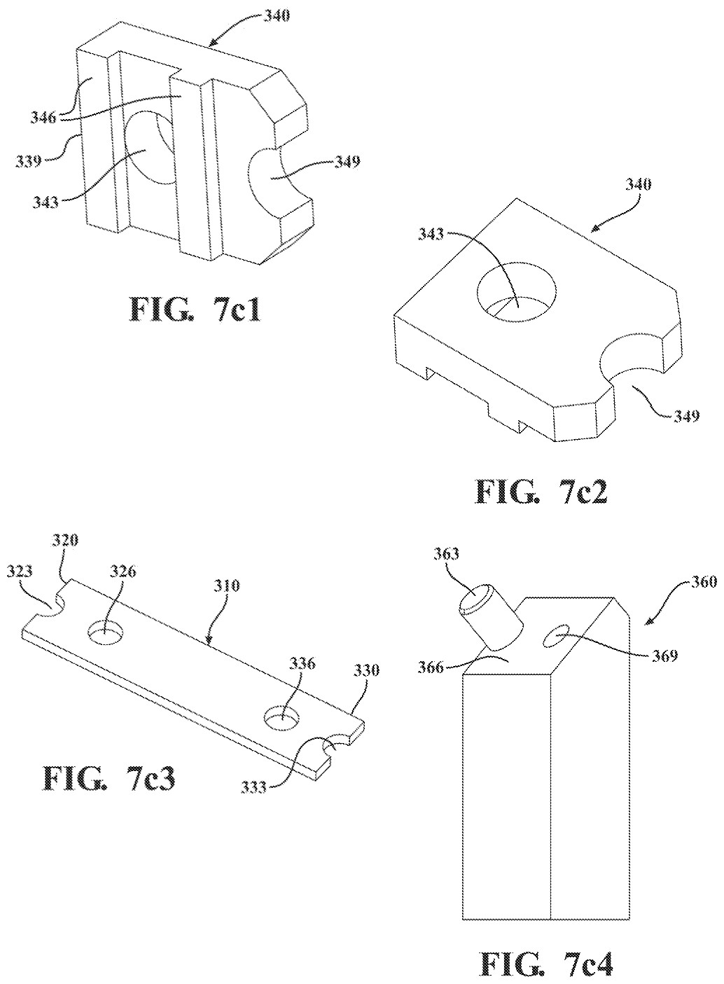

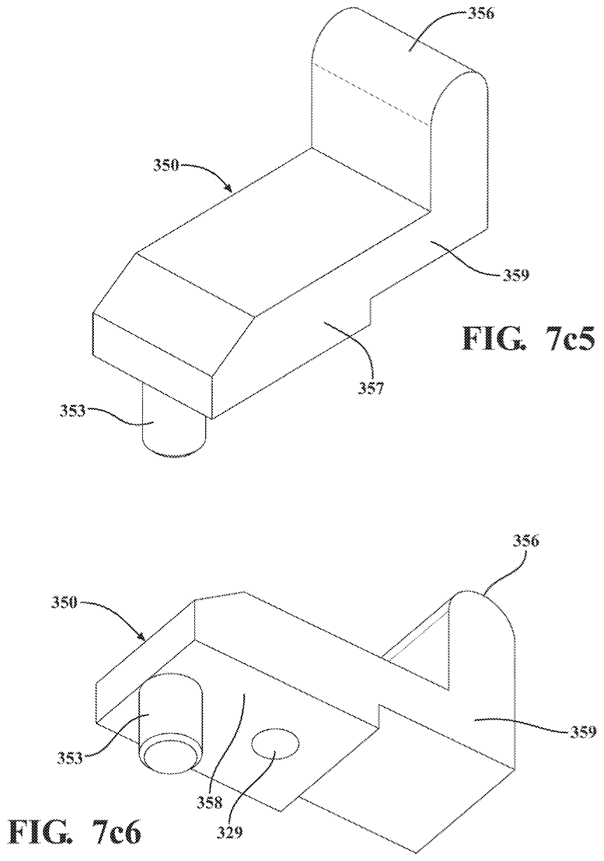

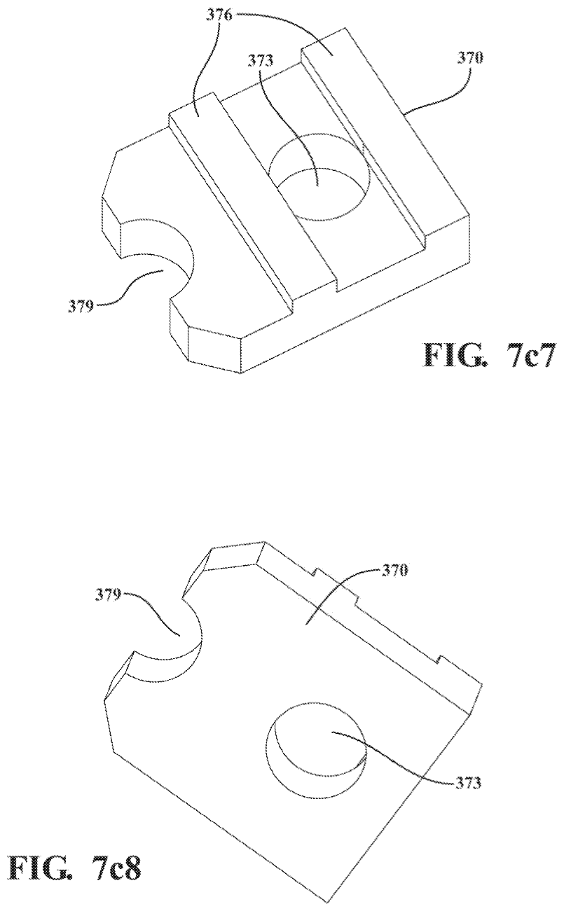

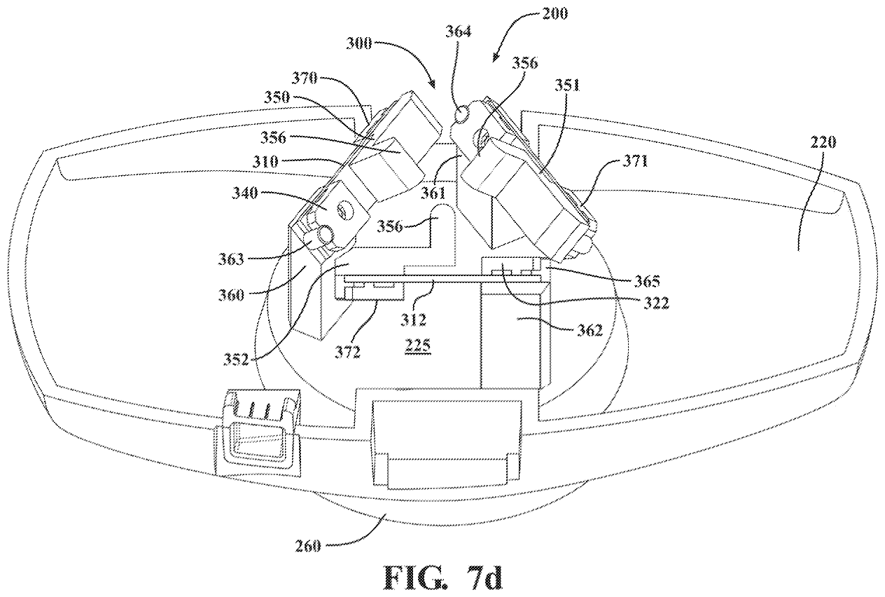

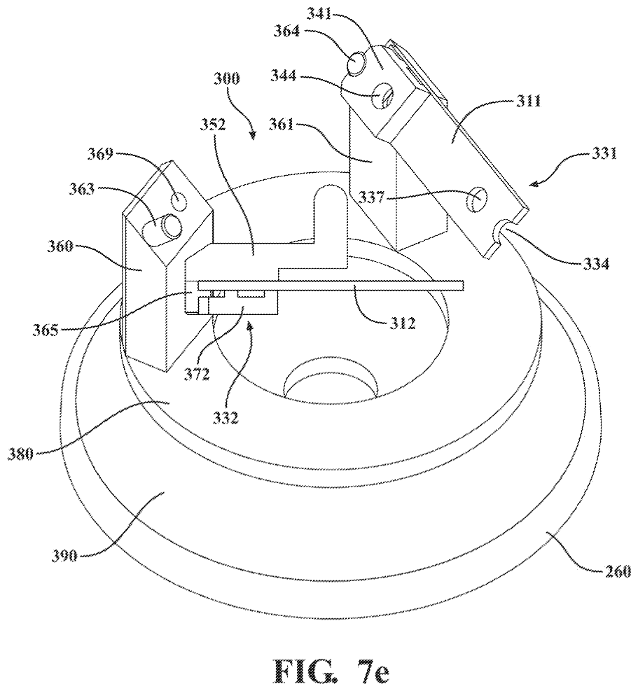

It should be noted that although three inverted beams 160, 161 and 162 are disclosed in the present embodiment, three or more inverted beams may be employed according to the teachings herein. The same teachings may be employed to the beams comprising the sensor 180 described in detail in FIG. 3c. It should be noted that the radially symmetric beams 160, 161 and 162 may have a different orientation for packaging or “footprint” purposes, an example of which is shown in FIG. 7b.

In a rotational isometry, an object which rotates about a rotocenter by an angle θ looks the same after the rotation as before. To be an isometry, a ray from the rotocenter to a point on the object is the same length as a ray from the rotocenter to an identical point on the “rotated” object. The angle θ measured between the rays RA and RA′, RA′ and RA″, RA″ and RA is the same, and the lengths of RA, RA′ and RA″ are the same. In the embodiment of FIG. 3b, each one of the inverted beams 160, 161 and 162 may be a rotational isometry and therefore, congruent. It should be evident to those skilled in the art that the same teachings disclosed with regard to the inverted beams 160, 161 and 162 may also be applied to beams 130, 131 and 132.

In operation, an input force applied to the rod 102 is transferred to the load element 110 which decomposes the input force into component forces. If the component forces are directed away from the load cell 100, the component forces are measured by the inverted sensor 190. The shoes 150 of the inverted sensor 190 contact the load element 110 at a tangent to the surface 120. Each beam 160, 161 and 162 reacts to their respective component force. The component forces causes each beam 160, 161 and 162 to react by bending, which is measured by the respective strain gauges.

A three dimensional load is measured by providing a pivotally movable load element 110 that pivots in response to an input force. The pivotally movable load element 110 balances the system by aligning itself with the direction of the input force. An input force applied away from the load cell 100 is measured by providing an inverted sensor 190 comprising three inverted beams 160, 161 and 162 and constraining their respective fixed ends 163, 164 and 165. The respective free ends 166, 167 and 168 are free to deflect independently from a component force applied by the load element 110. As described in more detail herein, each beam 160, 161 and 162 measures a component of the input force to determine the magnitude and direction of the input force without being affected by a spurious force. This is accomplished by permitting the load element 110 to pivot, thereby decoupling torque from the system. The load element 110 is not attached to the sensor 190.

Referring now to FIG. 3c a bottom view of the load cell 100 of FIG. 3a is shown having a sensor 180 comprising three radially symmetric beams 130, 131 and 132 spaced about the central axis C. The beams 130, 131 and 132 are disposed to deflect from an input force applied by the lower hemisphere 114 of the load element 110. The beams 130, 131 and 132 may be congruent. Each of the beams 130, 131 and 132 has a fixed end 133, 134 and 135 and a free end 136, 137 and 138 respectively. Each beam 130, 131 and 132 is operatively constrained at their respective fixed end 133, 134 and 135, and in the immediate embodiment, by the frame 80. The free end 136, 137 and 138 of each of the beams 130, 131 and 132 is disposed to deflect independently from a component force applied by the load element 110. The sensor 180 contacts the load element 110 at a tangent to the surface 120 of the load element 110 at a lower hemisphere 114. Each of the beams 130, 131 and 132 has a strain gauge (not shown) operatively bonded to each one of the beams 130, 131 and 132.

In operation, an input force applied to the rod 102 is transferred to the load element 110 which then decomposes the input force into component forces. If the component forces are directed toward the load cell 100, the component forces are measured by the sensor 180. The shoes 150 of the sensor 180 contact the load element 110 at a tangent to the surface 120. Each beam 130, 131 and 132 reacts to their respective component force. The component forces causes each beam 130, 131 and 132 to react by bending, which is then measured by the respective strain gauge.

A three dimensional load is measured by providing a pivotally movable load element 110 that pivots in response to an input force. The pivotally movable load element 110 balances the system by aligning itself with the direction of the input force. An input force applied toward the load cell 100 is measured by providing a sensor 180 comprising three beams 130, 131 and 132 and constraining their respective fixed ends 133, 134 and 135. The respective free ends 136, 137 and 138 are free to deflect independently from a component force applied by the load element 110. As described in more detail herein, each beam 130, 131 and 132 measures a component of the input force to determine the magnitude and direction of the input force without being affected by a spurious force. This is accomplished by permitting the load element 110 to pivot, thereby decoupling torque from the system. The load element 110 is not attached to the sensor 180.

Referring now also to FIG. 3d, a perspective view of the load cell 100 of FIG. 3a is shown having three inverted beams 160, 161 and 162 axially spaced along central axis C and inverted with respect to the beams 130, 131 and 132. The inverted beams 160, 161 and 162 and beams 130, 131 and 132 are disposed to receive the pivotally movable load element 110. The load cell 100 of the embodiment disclosed in FIG. 3a is a “push pull” load cell. The load cell 100 measures an input force applied to the beams 130, 131 and 132 when the input force is directed toward the load cell 100, also known as a “push” force. The load cell 100 also measures an input force applied to the inverted beams 160, 161 and 162 when the input force is directed away from the load cell 100, also known as a “pull” force. In addition to the “push only” load cell 100 of FIG. 2b, a “pull only” embodiment is considered to be within the scope of the teachings herein.

Referring now to FIG. 3e, a side view of the load cell of FIG. 3a with the upper chassis 92, inverted beams 160, 161, 162 and spacers 95 removed to reveal the pivotally movable load element 110 in two positions: perpendicular and pivoted at an angle Ψ. In the present illustration, an input force, force vector \vec{F}, has caused pivotally movable load element 110 to pivot from Z to Z′ by angle Ψ to align the load element 110 with the direction of force vector \vec{F}, indicated by Z′.

Referring now also to FIG. 3f, a bottom view of the load cell 100 of FIG. 3a is shown with the load element 110 in a balanced state after being pivoted by force vector \vec{F}. The load element 110 moves independent of the beams 130, 131 and 132 which permits decoupling of torque and provides a more accurate force measurement. The force vector \vec{F} is shown decomposed into three vector component forces Fᵢ, Fⱼ and Fₖ. The three dimensional vector component forces Fᵢ, Fⱼ and Fₖ are measured by each beam 130, 131 and 132, respectively. The amplitude of each force Fi, Fj and Fk, measured by beams 130, 131 and 132 are used to calculate the magnitude of the force vector \vec{F} and its direction. The component forces are applied normal to the beams: component force Fᵢ is applied to beam 130, component force Fⱼ is applied to beam 131, and component force Fₖ is applied to beam 132.

Referring now also to FIG. 3g, a perspective view of the load cell 100 of FIG. 3f is shown with the load element 110 removed and a normal vector to the surface of each beam is shown to reveal the face angle β. In the present embodiment, the face angle β=90°. Two planes are perpendicular if their normal vectors are perpendicular. Like the orthogonal directions X, Y, and Z in a three dimensional coordinate system, Fᵢ, Fⱼ and Fₖ are component forces. Each beam 130, 131 and 132 is operatively constrained at an attitude identified by angle α. In the present embodiment, each beam 130, 131 and 132 has an attitude of 45°. By having a 45° attitude for each beam 130, 131 and 132, the face angle β=90° between each adjacent beam 130, 131 and 132. Accordingly, the face angle β for contact shoes 150 is 90°. Having the component forces at right angles to each other, as x, y and z are at right angles in a Cartesian coordinate system, simplifies calculations. Also, the contact shoes 150 being located at a tangent to the surface 120 of the load element 110, more closely approximate a single contact point, increasing precision.

The magnitude of the force vector \vec{F} may be calculated by the square root of the sum of the squares method. The magnitude of force vector \vec{F} may be calculated by the following formula F=\sqrt{Fᵢ²+Fⱼ²+Fₖ²}. The beams 130, 131 and 132 may be constrained at an attitude other than 45° and such should be considered to be within the scope of the present disclosure and is discussed further below herein.

By allowing the load element 110 to pivot, a more accurate measurement of the force vector \vec{F} may be made. Since the load element is not connected to either sensor 180, 190, no moment arm can be present. As the load element 110 pivots in response to the direction of the input force, the beams 130, 131 and 132 measure the amplitude of each component forces Fᵢ, Fⱼ and Fₖ without damage to the load cell and without the presence of a parasitic load. The component forces Fᵢ, Fⱼ and Fₖ measured by the beams 130, 131 and 132, respectively, can either be positive or 0, no negative loads are present because the sensors 180, 190 are not connected to the load element 110. Decoupling torque assures that no parasitic loads are present. It should be evident to those skilled in the art that the same teachings disclosed with regard to the beams 130, 131 and 132, will apply to the inverted beams 160, 161 and 162.

Although the present embodiment discloses three (3) beams, it should be understood that three (3) or more beams may be employed within the teachings of the present disclosure. If x is the number of beams, the input forces: F₁, F₂, F₃, . . . , Fₓ measured by each corresponding beam may be resolved into component forces, and by summing common components, the square root of the sum of the squares method may be used to determine the magnitude of the force vector. The direction vector for each coordinate axis would be determined by calculating the inverse cosine of each component force divided by the magnitude of the force vector.

Referring now to FIG. 4a, a plan view of lower chassis 90 and beams 130, 131 and 132 of load cell 100 is shown. Each of the beams 130, 131 and 132 is operatively constrained at their respective fixed end 133, 134 and 135 and extends from their respective fixed end 133, 134 and 135 along a centerline ℄ to their respective free end 136, 137 and 138. Each beam 130, 131, 132 is spaced by of angle θ, which is determined by θ=360/n where n=the order of rotation. Recall that the order of rotation is equal to the number of beams in the respective sensor. In the present embodiment, a contact shoe 150 is operatively attached to each beam 130, 131 and 132 adjacent to said free end 136, 137, and 138, respectively, to contact the load element 110.

The fixed end 133, 134, 135 of each of the beams 130, 131, 132 may be operatively constrained to the frame 80 and or the lower chassis 90 by any means known in the art. In the preferred embodiment, each of the beams 130, 131, 132 and the frame 80 and or the lower chassis 90 is machined from a single piece of metal and is a unitary component. However, it is within the scope of the present disclosure for the fixed end 133, 134, 135 of beams 130, 131, 132 to be operatively constrained by the use of a fastener and retainer, an interference fit into the frame 80 and or the lower chassis 90, utilizing mechanical elements such as keys, pins, or slots (not shown) or attached to the frame 80 and or the lower chassis 90 by any suitable means known in the art.

Referring now to FIG. 4b, a perspective view of the pivotally movable load element 110 of one embodiment of the present disclosure is shown. The load element 110 is pivotally movable about a pivot point P. In the present embodiment, the rotocenter R is shown located at the same location as the pivot point P. However, the rotocenter R is located along the central axis C. The pivot point P is located in the center of the load element 110. Pivot point P is also located on the local Z axis of load element 110. The load element 110 moves independent of the frame 80 (not shown) and logically, sensors 180, 190, which in the present embodiment are supported by the frame 80.

The load element 110 has at least one spherical surface 120. In the present embodiment load element 110 has a surface 120 that is substantially spherical, that is, a completely spherical surface less a connection surface, for example, the rod 102 connection surface. The load element 110 may have a surface 120 that is a generally spherical, a surface that is necessary to assure spherical contact with the sensors 180, 190. It should be understood that the surface 120 of the load element 110 may comprise one or more spherical segments. The spherical surface 120 of load element 110 is shown bisected by the equatorial plane X-Y into an upper hemisphere 112 and a lower hemisphere 114. The load element 110 is pivotable about pivot point P in response to a force, for example as shown in the present illustration, by an angle Ψ, moving the local z-axis from Z to Z′.

Referring now to FIG. 4c, a perspective view of a sensor 180 is shown comprising beams 130, 131 and 132. Strain gauges 140, 141 and 142 are operatively bonded to the beams 130, 131 and 132, respectively. Each beam 130, 131 and 132 has an x-axis along its longitude. Each beam 130, 131 and 132 is operatively constrained at an angle α, measured relative to the horizon, and referred to as attitude. The attitude may range from 0° (flat) to 90° (perpendicular). The attitude may be adjusted by pivoting the beams 130, 131 and 132 about their x-axis. In the best mode the attitude is 45°. A 45° attitude provides a 90° angle between adjacent beams comprising sensor 180. The perpendicular arrangement of beams 130, 131 and 132 provides measurement of the amplitude of each component vector by each one of the beams 130, 131 and 132. The beams 130, 131 and 132 are preferably rectangular in cross sectional shape, however any suitable cross sectional shapes may be substituted for a rectangular section, including, but not limited to, square or round.

The beams 130, 131 and 132 may be designed with different lengths, widths, sections and thicknesses based on the design criteria. In the present embodiment, the beams 130, 131 and 132 all share a common support structure, which is chassis 90. The strain gauges 140, 141 and 142 are mounted on the beams 130, 131 and 132 to measure a compression force on each beam. Since each beam 130, 131 and 132 may only measure compression, where compression is a positive measurement, or 0, torque effects are completely eliminated. Load element 110, such as that shown in FIG. 4b, moves independently of the sensor 180, and therefor, cannot impart a negative measurement on the beams 130, 131 and 132.

Referring now to FIG. 4d, a perspective view of a load cell 100 is shown having a pivotally movable load element 110 in contact with inverted sensor 190. The inverted sensor comprises beams 160, 161 and 162. Beams 160, 161 and 162 have strain gauges 170, 171 and 172 bonded thereon to measure a compression force on each beam. In the preferred embodiment a sensing bridge is applied to each beam 160, 161 and 162. A sensing bridge means each of the strain gauges 140, 141, 142, 170, 171 and 172 are coupled to a Wheatstone bridge (not shown) located on each beam and four (4) wires (V_{EX}+, V_{EX}−, Vₒ+, Vₒ− not shown) for each sensing bridge leads to a circuit board 40 of FIG. 5. Alternatively, the bridge circuits may theoretically be located on the circuit board 40, although it would not be optimal.

Referring now to FIG. 5, an illustration of a circuit board 40 is shown. The circuit board 40 has a microcontroller 50, which in the present embodiment is an ESP-WROOM-32 manufactured by Espressif Systems. The microcontroller 50 includes a CPU, ROM (read only memory), RAM (random access memory) and I/O (input/output) ports. The internal ROM stores booting and core functions, while on-board RAM stores data to be processed by the CPU and instructions to be executed by the CPU. The I/O ports are an interface to external circuitry. The microcontroller 50 supports external flash chips, which is a form of non-volatile memory. A non-volatile memory chip 60 is in communication with the microcontroller 50. Non-volatile memory 60 is adapted for storing a program having instructions for processing signal data. Signals from the strain gauges arrive as an analog signal.

A display connector 61 provides signals to a display screen (not shown). A USB port 62 provides power and communication for configuration and data transfer if the data is not stored in non-volatile memory 60. IC 64 is a USB hub that enables the USB to communicate with non-volatile memory 60 and the microcontroller 50 at the same time.

A strain gauge is a resistor whose resistance varies with the strain in the material to which it is bonded. A bridge circuit converts the strain induced resistance to a differential voltage by applying an excitation voltage to the bridge circuit. This differential voltage is the signal used for measurement. The signal is a continuous time signal which means it is an analog signal and will require conversion to a digital signal by an A/D converter before storage or processing by the CPU. The signal produced by the bridge circuit is typically very small. In the best mode, the signal is amplified and offset to match the span of the A/D converter. In the present embodiment, signals received from the strain gauges are converted from analog signals to signal data by an analog to digital converter 66. The signal data is a sequence of discrete values. Signal data from the analog to digital converter 66 may be stored in the non-volatile memory 60 or external to the board 40. The CPU executes program instructions to process the signal data. The signal data represents a value of force applied to the beams. By applying the gauge factor and Hooke's law, stress may be computed and thereby strain measurements represent a value of force.

Force is the influence exerted on an object, simply Mass×Acceleration. On Earth, one pound of mass exerts one pound of force due to gravity. A one pound force is defined as the force required to accelerate an object of 1 pound mass at a rate of 32.174 ft/s², therefore 1 lbf=32.174 lbm*ft/s² and the units for force are measured by lbm*ft/s². Energy is the capacity for doing work. Work is the result of a force acting over some distance, that is Force×Distance, or lbm*ft²/s². The U.S. measurement for energy and work is the same, which is the foot-pound. Energy is a measure of how much work can be done without taking into account the time it takes to complete the work. Power is Work/Time, or lbm*ft/s. James Watt created the term “horsepower” to compare his steam engine to the power of a horse, which is the power to move a 330 lbf load 100 feet in one minute. By applying distance and time to force measurements, energy and power, respectively, may also be calculated by the CPU.

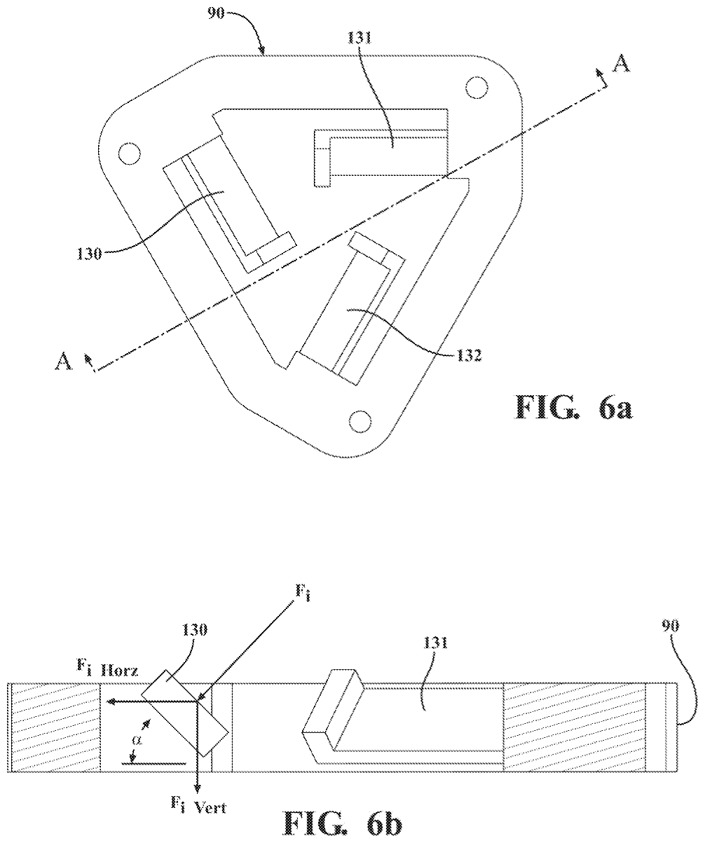

Referring now to FIG. 6a, a plan view of a lower chassis 90 and beams 130, 131 and 132 is shown with a section cut A-A through the lower chassis 90. Referring now also to FIG. 6b, a section cut along A-A of FIG. 6a is shown to reveal component force Fᵢ acting on beams 130 decomposed into a F_{i Horz} (horizontal) subcomponent and a F_{i Vert} (vertical) subcomponent. The load cell 100 of the present disclosure may be adapted to incorporate three or more beams and an attitude that is an angle other than 45° by decomposing the amplitude of a force measured by a beam into horizontal and vertical subcomponents and summing the common subcomponents. The subcomponents can be computed as F_{i Vert}=Fᵢ*Cosine α and F_{i Horz}=Fᵢ*Sine α. By applying a planar coordinate system in the horizontal plane, a planar direction and magnitude may be computed.

Referring now to FIG. 7a, a perspective view of one embodiment of a force measurement device 200 according to the principles of the present disclosure is shown. The device 200 has a housing 205, which in the present embodiment, is a half shell design consisting of a half shell top 210 and a half shell bottom 220. The housing 205 protects the internal components from external influences. Three lobes 356 extend through the half shell top 210 to receive a spherical load element, such as the load element shown and described in FIG. 4b. It should be noted that less than a full sphere, for example, a half sphere, may be employed in the present embodiment. A latch 230 is provided for securing the half shell top 210 to the half shell bottom 220. A display screen 250 is provided for displaying information to a user. A port 240 is provided for communicating with the device 200. A mount 260 is provided for securing the device 200 to a surface.

Referring now to FIG. 7b, a perspective view of the force measurement device 200 of FIG. 7a is shown with half shell top 210, latch 230 and screen 250 removed to reveal a three dimensional load cell 300 according to the teachings of the present disclosure. The load cell 300 has a sensor 305 which comprises three radially symmetric beams 310, 311 and 312 spaced about a central axis C. Each one of the beams 310, 311 and 312 has a fixed end 320, 321 and 322 and a free end 330, 331 and 332 respectively. The free end 330, 331 and 332 of each beam 310, 311 and 312 is free to deflect. Each of said beams 310, 311 and 312 are disposed to deflect independently from a component force applied by the load element (not shown). Each beam 310, 311 and 312 is operatively constrained at their respective fixed end 320, 321 and 322. The beams 310, 311 and 312 may be congruent. The positioning of beams 310, 311 and 312 differs from beams 132, 133 and 134 of FIG. 3C in that the beams 310, 311 and 312 have been translated along their x-axis (see FIG. 4c) to reduce the “footprint” of the loads cell 300. The fixed end 320, 321 and 322 of each beam 310, 311 and 312 is interposed between a top plate 340, 341 and 342 and a pedestal 360, 361 and 362, respectively and clamped into place, preferably by a threaded fastener (not shown). The fastener passes through an aperture in each top plate 340, 341 and 342 and an aperture 326 adjacent to the fixed end 320, 321 and 322 of each beam 310, 311 and 312 before engaging the respective pedestal 360, 361 and 362 to apply a clamping force.

Referring now also to FIGS. 7c1 and 7c2, top plate 340 is shown in a perspective view having a pair of parallel lands 346 on either side of an aperture 343, and a radial recess 349. In the present embodiment, each top plate 340, 341 and 342 has the same features as top plate 340 described in FIGS. 7c1 and 7c2. Referring now also to FIG. 7c3, a perspective view of beam 310 is shown having a fixed end 320 with a radial recess 323 adjacent to an aperture 326 and a free end 330 with a radial recess 333 adjacent to an aperture 336. In the present embodiment, each beam 310, 311 and 312 has the same features as beam 310 described in FIG. 7c3. Referring now also to FIG. 7c4 a perspective view of pedestal 360 is shown having a locating pin 363 projecting from a face 366. The face 366 is formed at an angle to provide an attitude to beam 310. A blind hole 369 is located in the face 366 of pedestal 360, which may be tapped for receiving a threaded fastener (not shown). In the present embodiment, each pedestal 360, 361 and 362 has the same features as pedestal 360 described in FIG. 7c4.

The radial recess 349 of top plate 340 and recess 323 of beam 310 align and cooperate with locating pin 363 to achieve positional accuracy and to eliminate pivoting of the beam 310 with respect to pedestal 360 when attaching the beam 310. Each of the beams 310, 311 and 312 include radial recesses and apertures as described with reference to beam 310. The radial recess 349 in each top plate 340, 341 and 342 aligns with the radial recess 323 at the fixed end 320, 321 and 322 of each beam 310, 311 and 312 for locating against a pin 363, 364 and 365 in each pedestal 360, 361 and 362. Each top plate 340, 341 and 342 has a pair of parallel lands 346, 347 and 348, respectively, the parallel lands 346, 347 and 348 are positioned on either side of an aperture 343, 344 and 345, to assure the clamping load is distributed perpendicular to the load axis of a fastener (not shown). Flat and parallel lands also prevent a bending stress from being induced in the fastener where the load—about 75% of yield—applied from the outermost point of the bolt head to the central axis of the fastener creates a significant bending moment. Use of a plate increases accuracy of a bending beam compared to a threaded fastener alone. As is known by those skilled in the art, a bolt will compress plates with a force distribution in the shape of a frusta, spreading from the bolt head. The lands 346, 347 and 348 distribute a clamping force uniformly across the width of the top plates 340, 341 and 342. Additionally, the lands 346, 347 and 348 of the top plates 340, 341 and 342 permit no deflection at the square edge 339.

A contact shoe 350, 351 and 352 is attached to each beam 310, 311 and 312 adjacent to their respective free end 330, 331 and 332. Referring now also to FIGS. 7c5 and 7c6, contact shoe 350 is shown in a perspective view having a base 357 with a face 358. A locating pin 353 extends from the face 358. A blind hole 329 is located in the face 358, which may be tapped for receiving a threaded fastener (not shown). A 90° lever 359 extends from the base 357, the lever 359 terminates in a lobe 356 where the lobe 356 is disposed to contact a load element (not shown) at a tangent to the surface of the load element.

The free end 330, 331 and 332 of each beam 310, 311 and 312 is interposed between a contact shoe 350, 351 and 352 and under plate 370, 371 and 372, respectively and, and in the preferred embodiment, clamped using a threaded fastener (not shown). The fastener passes through an aperture 373 in each under plate 370, 371 and 372 and an aperture 336 adjacent to the free end 330, 331 and 332 of each beam 310, 311 and 312 before engaging the respective contact shoe 350, 351 and 352 to apply a clamping force.

Referring now also to FIG. 7C7 and 7C8, under plate 370 is shown in a perspective view having a pair of parallel lands 376 on either side of an aperture 373 and a radial recess 379. In the present embodiment, each under plate 370, 371 and 372 has the same features as top plate 340 described in FIG. 7C1 and 7C2. The radial recesses 379, 333 of under plate 370 and beam 310 align and cooperate with locating pin 353 of contact shoe 350 to achieve positional accuracy and to eliminate pivoting of the beam 310 with respect to the contact shoe 350.

A circuit board 400 is supported within the housing 205 and contains circuitry as described with reference to FIG. 5. Strain gauges (not shown) provide a strain induced resistance that varies with the component force applied to each beam 310, 311 and 312. A strain gauge (not shown) is operatively bonded to each one of the beams 310, 311 and 312.

Resistance measurements of the strain gauges may be converted to voltage signals on the beams 310, 311 and 312 or the board 400. The signals are communicated to the circuit board 400. The signals are preferably conditioned on the board 400 by being amplified and offset to match the span of an on-board A/D converter. The signals are converted to a digital signal referred to herein as signal data. Circuitry on the board 400 includes a CPU that receives signal data, executes instructions for processing signal data and processes signal data. The board 400 is in communication with the display screen 250 for displaying information to a user.

Referring now to FIG. 7d, a perspective view of the force measurement device 200 of FIG. 7b is shown with the circuit board 400 removed to more clearly reveal the three dimensional load cell 300. In the present embodiment, base 225 is integral to the half shell bottom 220 of the housing 205. The base 225 supports pedestals 360, 361 and 362 which operatively constrain each beam 310, 311 and 312 at their respective fixed end 320, 321 and 322.

Each face 366, 367 and 368 of the pedestals 360, 361 and 362 is formed an angle which causes the beams 310, 311 and 312 to be operatively constrained at an attitude forming a 90° angle with respect to each beam 310, 311 and 312. An input force from a load element (not shown) is decomposed into component forces and transmitted to the beams 310, 311 and 312 for measurement. Each contact shoe 350, 351 and 352 has a lobe 356 that contacts a load element (not shown), the contact shoe 350, 351 and 352 rigidly transfers each component force to the respective beam 310, 311 and 312 for measurement. A mount 260 is attached to the housing 205 to secure the force measurement device 200 to a body (not shown) subject to an input force.

Referring now to FIG. 7e, a perspective view of an alternative force measurement device of FIG. 7c is shown with the with circuit board 400, half shell bottom 220, pedestal 362, beam 310 and contact shoes 350 and 351 removed to more clearly view components of the three dimensional load cell 300. An annular base 380 supports the pedestals 360, 361 and 362 (not shown). Pedestal 360 has a locating pin 363 and blind hole 369 for operatively constraining the fixed end 320 (not shown) of beam 310 (not shown). Pedestal 361 operatively constrains beam 311 with locating pin 364 and top plate 341 by clamping beam 311 between top plate 341 and pedestal 361 by the use of a fastener (not shown). Locating pin 364 provides precise location and prevents rotation of beam 311.

The free end 331 of beam 311 shows the aperture 337 used to secure contact shoe 351 (not shown) and radial recess 334 is used to locate contact shoe 351 (not shown). Contact shoe 352 is shown secured to beam 312 adjacent to free end 332 of beam 312 by clamping under plate 372 to contact shoe 352. A suction cup 30 is provided for securing the force measurement device 200 to a body (not shown).

It will be appreciated that the aforementioned method and devices may be modified to have some components and steps removed, or may have additional components and steps added, all of which are deemed to be within the spirit of the present disclosure. Even though the present disclosure has been described in detail with reference to specific embodiments, it will be appreciated that the various modifications and changes can be made to these embodiments without departing from the scope of the present disclosure as set forth in the claims. The specification and the drawings are to be regarded as an illustrative thought instead of merely restrictive thought.

What is claimed is:

1. A load cell, comprising:
a pivotally movable load element having at least one spherical surface; and
a sensor disposed to receive said load element.

2. The load cell of claim 1, wherein said sensor comprises at least three radially symmetric beams spaced about a central axis, each of said beams having a fixed end and a free end, each of said beams operatively constrained at said fixed end and free to deflect at said free end, each of said beams disposed to deflect independently from a component force applied by said load element, each one of said beams having a strain gauge operatively bonded to said beam.

3. The load cell of claim 1, wherein said movable load element has a generally spherical surface.

4. The load cell of claim 2, wherein each one of said at least three beams being constrained at a non-zero attitude.

5. The load cell of claim 2, further comprising a contact shoe operatively attached adjacent to said free end of each one of said beams.

6. The load cell of claim 2, wherein said beams are spaced at about 120 degrees.

7. The load cell of claim 2, wherein said sensor contacts said load element at a tangent to the surface of said load element.

8. The load cell of claim 2, wherein each one of said at least three beams has an attitude of 45 degrees.

9. The load cell of claim 1, wherein said load element has an upper hemisphere and a lower hemisphere and said sensor being in contact with said lower hemisphere of said load element.

10. The load cell of claim 9, further comprising an inverted sensor, said inverted sensor being axially spaced from and inverted with respect to said sensor, said inverted sensor being in contact with said upper hemisphere of said load element.

11. The load cell of claim 10, wherein said inverted sensor comprises at least three inverted radially symmetric beams spaced about a central axis, each of said beams having a fixed end and a free end, each of said inverted beams operatively constrained at said fixed end and free to deflect at said free end, each of said inverted beams disposed to deflect independently from a component force applied by said load element, each one of said inverted beams having a strain gauge operatively bonded to said inverted beam.

12. The load cell of claim 11, wherein each one of said at least three inverted beams are constrained at a non-zero attitude.

13. The load cell of claim 11, further comprising a contact shoe operatively attached adjacent to said free end of each one of said inverted beams.

14. The load cell of claim 11, wherein said at least three inverted beams are rotationally spaced at about 120 degrees.

15. The load cell of claim 10, wherein said inverted sensor contacts said load element at a tangent to the surface of said load element.

16. A force measurement device, comprising:
a load cell having a pivotally movable load element having at least one spherical surface;
a sensor disposed to contact said load element at a tangent to the surface of said load element, said sensor comprising at least three radially symmetric beams spaced about a central axis, each one of said beams having a fixed end and a free end, each of said beams operatively constrained at said fixed end, each of said beams being free to deflect at said free end, each of said beams disposed to deflect independently from a component force applied by said load element, at least one strain gauge operatively bonded to each one of said beams, each of said strain gauges providing resistance measurements;
a bridge circuit connected to each of said strain gauges and a voltage source, said bridge circuit having a differential voltage output providing a voltage signal;
an analog to digital converter receiving the voltage signal and converting the voltage signal to signal data; and
a processor adapted for receiving signal data, executing instructions for processing signal data and processing signal data.

17. The device of claim 16, further comprising non-volatile memory adapted for storing signal data and a program containing instructions for processing signal data.

18. The device of claim 16, further comprising a display screen.

19. The device of claim 16, further comprising an inverted sensor, said inverted sensor being axially spaced from and inverted with respect to said sensor, said inverted sensor being in contact with said load element at a tangent to the surface of said load element.

20. A force measurement device, comprising:
a housing;
a load cell, said load cell having a pivotally movable load element with at least one spherical surface;
a base supporting at least three pedestals;
a sensor comprising at least three radially symmetric beams spaced about a central axis, each one of said beams having a fixed end and a free end, each of said beams operatively constrained at said fixed end by each of said at least three pedestals, each of said beams being free to deflect at said free end, each of said beams disposed to deflect independently from a component force applied by said load element, at least one strain gauge operatively bonded to each one of said beams, each of said strain gauges providing resistance measurements;
a bridge circuit connected to each of said strain gauges and a voltage source, said bridge circuit having a differential voltage output providing a voltage signal;
a circuit board having an analog to digital converter receives the voltage signal and converts the voltage signal to signal data, non-volatile memory adapted for storing a program having instructions and signal data, and a processor adapted for receiving signal data from said non-volatile memory, executing instructions for processing signal data and processing signal data; and
a display screen in communication with said circuit board.
